(19) United States
(12) Patent Application Publication
(10) Pub. No.: US 2018/0336561 A1
(43) Pub. Date: Nov. 22, 2018

(54) SPEND-PROFILE BASED TRANSACTION VALUE LIMITS FOR PIN-LESS CONTACTLESS PAYMENT-CARD AUTHORIZATIONS

(71) Applicant: MasterCard International Incorporated, Purchase, NY (US)

(72) Inventor: David Sadlier, Dublin (IE)

(21) Appl. No.: 15/597,405

(22) Filed: May 17, 2017

(51) Int. Cl. G06Q 20/40; G06Q 20/32

(52) U.S. Cl. CPC G06Q 20/4012; G06Q 20/327

(57) ABSTRACT

Records of payment account transactions are stored. All the transactions pertain to a certain category of merchants and are performed by the same account holder. A request for a contactless payment account transaction is received from the account holder for a transaction with a merchant in that certain category. Outlier detection analysis is performed regarding the request based on the stored records of transactions. Based on a result of the analysis, it is determined whether to require PIN entry for the requested transaction.

### BACKGROUND

FIG. 1 is a block diagram that illustrates a conventional payment system 100.

The system 100 includes a conventional payment card/device 102. As is familiar to those who are skilled in the art, the payment card/device 102 may be a magnetic stripe card, an IC (integrated circuit) card, a fob, a payment-enabled smartphone, etc. The payment card/device 102 is shown being carried and used by an account holder/user 103.

The system 100 further includes a reader component 104 associated with a POS terminal 106. In some known manner (depending on the type of the payment card/device 102) the reader component 104 is capable of reading the payment account number and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate in a conventional manner to receive an authorization request for the transaction from the POS terminal 106. The acquirer computer 108 may route the authorization request via a payment network 110 to the server computer 112 operated by the issuer of a payment account that is associated with the payment card/device 102. As is also well known, the authorization response generated by the payment card issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment account issuer server computer 112 may be operated by or on behalf of a financial institution (“FI”) that issues payment accounts to individual users. For example, the payment account issuer server computer 112 may perform such functions as (a) receiving and responding to requests for authorization of payment account transactions to be charged to payment accounts issued by the FI; (b) tracking and storing transactions and maintaining account records; (c) rendering periodic account statements; (d) receiving and tracking payments to the issuer from the account holders; and (e) clearing transactions.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number to the reader component of a POS terminal.

Referring again to the payment card/device 102 and the reader component 104, some conventional types of interactions between those devices will now be described in more detail.

If the payment card/device 102 is a magnetic stripe card, it may be the case that the magnetic stripe portion (not separately shown) is swiped through a card-stripe reading slot (not separately shown) on the reader component 104 so that the reader component 104 may read card data magnetically stored on the magnetic stripe.

If the payment card/device 102 is an IC card, there are two well-known ways in which the card may be presented to the reader. If the card is of the “contact” variety, then it has electrically conductive contacts on the front surface of the card. The portion of the card having the contacts may be inserted into a chip-reading slot in the reader component 104 to allow an electrically conductive signal path to be established between the card chip (i.e., the IC on the card) and electronic components of the reader component 104, via the contacts on the card.

If the card is of the “contactless” variety (some cards support both contact and contactless operation), then the card includes a loop antenna or the like to support an exchange of short-range radio communications for data exchange between the card and the reader component 104. In practice, the card may be brought very close to, or briefly tapped on, a designated location on the housing (not separately shown) of the reader component 104 to permit the short-range radio communications to occur between the reader component 104 and the card.

If the payment card/device 102 is a payment-enabled mobile device, then it is typically configured to emulate the functionality of a contactless IC payment card. In such cases, the payment-enabled mobile device may be tapped on the designated location on the reader housing, again to permit an exchange of short-range radio communications.

Similarly, if the payment card/device 102 is a fob or similar device, again it may emulate the functionality of a contactless IC payment card.

One advantage of contactless interactions between the payment card/device 102 and the reader component 104 is that the corresponding payment account transactions may be accomplished very quickly and efficiently. Nevertheless, concerns for the security of contactless transactions tend to present a trade-off against speed and convenience. For many merchant locations, the trade-off is implemented by requiring the user/account holder 103 to enter a PIN (personal identification number), but only for transactions above a certain set amount (say USD 25.00 or 50.00).

The present inventor has now recognized an opportunity to improve the trade-off between speed/convenience on one hand versus transaction security on the other hand in connection with contactless payment account transactions.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional system that handles purchase transactions using a payment account at the point of sale.

FIG. 2 is a block diagram of a payment system according to some embodiments.

FIG. 3 is a schematic plan view of a conventional contactless IC payment card that may be used as a payment device in the system of FIG. 2.

FIG. 4 is a simplified block diagram illustration of a conventional payment-enabled mobile device that may be used as a payment device in the system of FIG. 2.

FIG. 5 is a block diagram representation of a computer that may serve as a component of the system shown in FIG. 2.

FIG. 6 is a flow chart that illustrates aspects of the present disclosure.

FIGS. 7 and 8 are graphs that illustrate aspects of outlier detection processing that may be applied to contactless payment transactions in accordance with aspects of the present disclosure.

FIG. 9 is a flow chart that illustrates aspects of the present disclosure.

### DETAILED DESCRIPTION

In general, and for the purpose of introducing concepts of embodiments of the present disclosure, a threshold for determining whether to require PIN entry in a contactless payment account transaction may be determined based on account-holder-by-account-holder and merchant-category-by-merchant-category records of account holder spending habits. The threshold may be based on an outlier detection analysis for detecting particular transactions that are outliers relative to the account holder's habitual spending patterns.

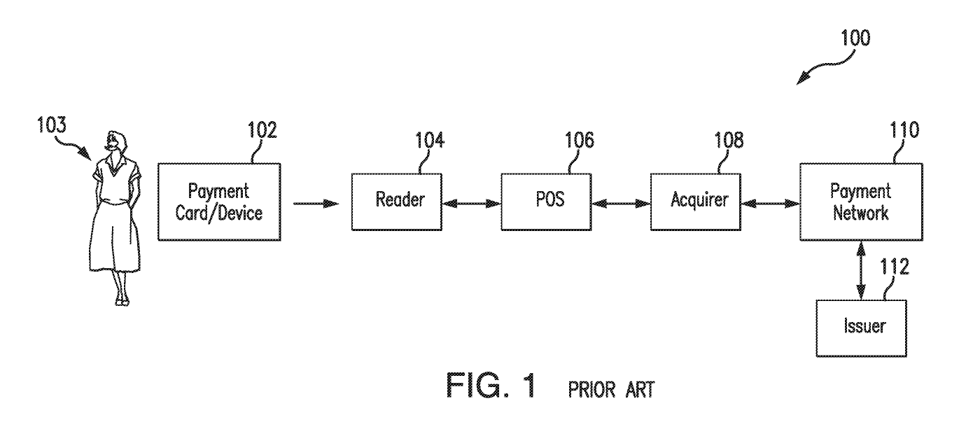

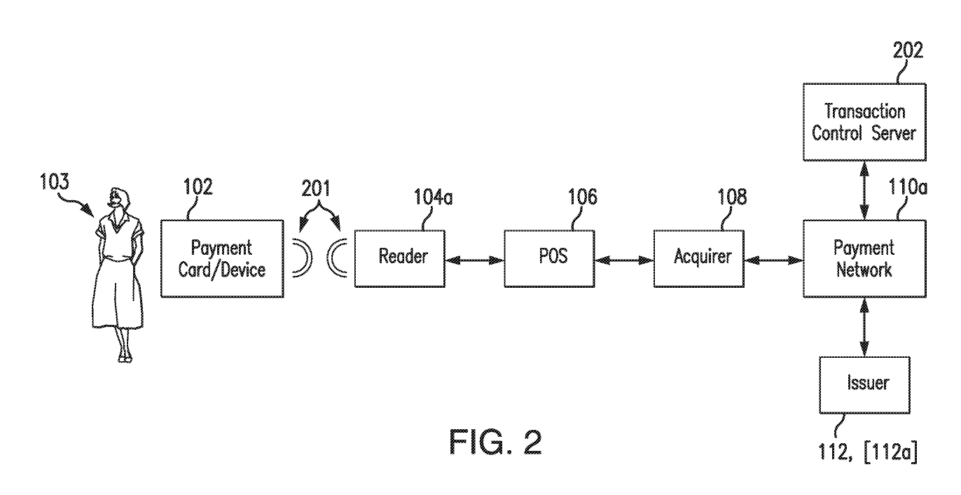

FIG. 2 is a block diagram of a payment system 200 according to some embodiments. Except for certain modifications as described herein, the payment system 100 may closely resemble the conventional payment system 100 as described above in connection with FIG. 1.

FIG. 2 again shows a user/account holder 103. In this case the payment device 102 carried by the user 103 is assumed to be one of the types of devices described above with which contactless payment account transactions are performed at the point of sale. Accordingly, the payment device 102 is shown at 201 engaging in short-range radio communications with the reader device 104a. The reader device 104a may differ, if at all, from the corresponding conventional component shown in FIG. 1 only in that the reader device 104a may not be programmed to enforce a fixed transaction amount threshold for requiring PIN entry. As is commonly the case, the reader device 104a may include a PIN-entry key pad, which is not separately shown. As will be seen, in some embodiments, the reader device 104a may be programmed to enforce a pre-determined standard threshold for PIN-entry for some transactions but not for others, possibly in dependence on prompts received via messaging from a remote computer or computers.

The payment system 200 may also include a POS device 106 connected to the reader device, to receive payment account information input to the POS device 106 from the payment device 102 via the reader device 104a. In arrangements where the POS device, rather than the reader device, would otherwise enforce a PIN-entry transaction amount threshold, the POS device may be modified in the same manner as was described in the previous paragraph relative to reader device 104a.

The payment system 200 may also include the acquirer computer 108 and the issuer computer 112, as described in connection with FIG. 1. In some embodiments, the issuer computer 112 may instead be an issuer computer 112a—i.e., modified in a manner as described below. Further, the payment system 200 includes a payment network 110a, modified to communicate with or incorporate a transaction control server computer 202, which is part of the payment system 200 and is provided according to aspects of the present disclosure. As will be described in further detail below, the transaction control server computer 202 may store records of payment account transactions and perform outlier detection analysis on new contactless payment account transaction requests to determine whether PIN entry should be required on the new transaction requests.

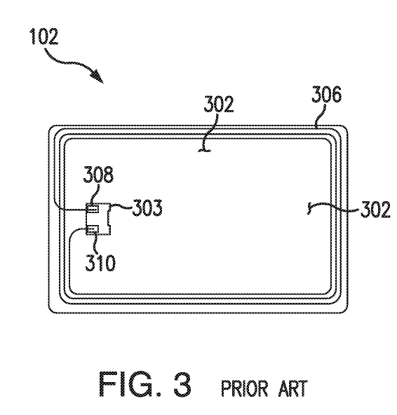

FIG. 3 is a schematic plan view of a conventional contactless IC payment card that may be used as a payment device 102 in the system of FIG. 2.

Referring to FIG. 3, in this embodiment, the payment device 102 has a support structure 302 that defines a card shaped body. The card shaped body may be formed of plastic or other suitable material. For example, the card shaped body has dimensions defined for the standard card referred to as “ID1” in ISO/IEC standard 7810, promulgated by the International Standardization Organization.

In this embodiment, the payment device 102 further includes an IC 303 and an antenna 306. The antenna 306 may be coupled to the IC 303 at connection points 308 and 310.

The antenna 306 may be mounted in, embedded in and/or otherwise supported by the card-shaped body. As shown, the antenna 306 may comprise several loops arranged along the periphery of the card-shaped body. Alternatively, the antenna 306 may be of a different type and/or configuration.

The IC 303 may include suitable circuitry for storing payment account data and related data typically stored in a payment device, as well as circuitry for engaging in data communications with contactless reader devices via the antenna 306.

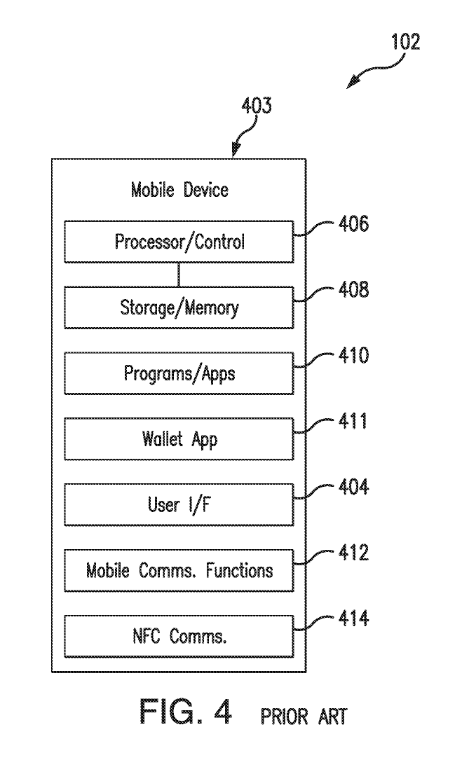

FIG. 4 is a simplified block diagram illustration of a conventional payment-enabled mobile device that may be used as a payment device 102 in the system of FIG. 2. For convenience in discussing FIG. 4, the payment device 102 shown therein will alternatively be referred to as the “mobile device 102”.

To some extent, it will be posited in the following discussion, without limitation, that the mobile device 102 is a smartphone.

The mobile device 102 may include a housing 403. In many embodiments, the front of the housing 403 is predominantly constituted by a touchscreen (not separately shown), which is a key element of the user interface 404 of the mobile device 102.

The mobile device 102 further includes a mobile processor/control circuit 406, which is contained within the housing 403. Also included in the mobile device 102 is a storage/memory device or devices (reference numeral 408). The storage/memory devices 408 are in communication with the processor/control circuit 406 and may contain program instructions to control the processor/control circuit 406 to manage and perform various functions of the mobile device 102. As is well-known, a smartphone may function as what is in effect a pocket-sized personal computer, via programming with a number of application programs, or “apps”, as well as a mobile operating system (OS). (The apps are represented at block 410 in FIG. 4, and may, along with other programs, in practice be stored in block 408, to program the processor/control circuit 406.)

Also shown in FIG. 4 is a wallet app 411. The wallet app 411 is shown apart from the other apps represented at block 410, in part due to the particular relevance of the wallet app 411 to the subject of this disclosure. In addition, the separate representation of the wallet app 411 also may be considered to represent the possibility that it is stored in a secured element (SE—not shown apart from block 411 or block 408), which may be provided in some embodiments of the mobile device 102 to provide enhanced security for the wallet app 411 and/or sensitive data associated therewith. The SE, if present, may be conventional in its hardware aspects. In addition or alternatively, security for the wallet app 411 may be enhanced by known alternatives to an SE, such as a TEE (trusted execution environment).

To the extent that the SE includes processing capabilities, it may functionally (though likely not physically) overlap with block 406; to the extent that the SE includes storage (and particularly program storage) capabilities, it may functionally (though likely not physically) overlap with block 408.

The wallet app 411 may have one or more digitized payment account cards/payment applications (not separately shown) associated therewith and accessible via the wallet app 411.

As is typical for smartphones, the mobile device 102 may include mobile communications functions as represented by block 412. The mobile communications functions may include voice and data communications via a mobile communication network (not shown) with which the mobile device 102 is registered.

In addition, to facilitate use as a payment-enabled device, the mobile device 102 may include short-range radio communications capabilities (block 414), including for example NFC (near field communication). Thus block 414 may represent a suitable antenna (not separately shown) that is appropriate for NFC communications as well as driving and receiving circuitry associated with the antenna. It will be appreciated that the NFC antenna may be separate and different from the antenna (not separately shown) utilized by the mobile device 102 for the mobile communication functions represented by block 412. With the NFC capability, the wallet app and one or more digitized payment account cards/payment apps, the mobile device 102 may be functional to be presented at a reader device 104/104a to execute a purchase transaction via contactless transaction processing with the point of sale.

From the foregoing discussion, it will be appreciated that the blocks depicted in FIG. 4 as components of the mobile device 102 may in effect overlap with each other, and/or there may be functional connections among the blocks which are not explicitly shown in the drawing. It may also be assumed that, like a typical smartphone, the mobile device 102 may include a rechargeable battery (not shown) that is contained within the housing 403 and that provides electrical power to the active components of the mobile device 102.

Although the mobile device 102 has been described herein primarily as a smartphone, in other embodiments, other types of mobile devices with similar capabilities may be used in place of a smartphone.

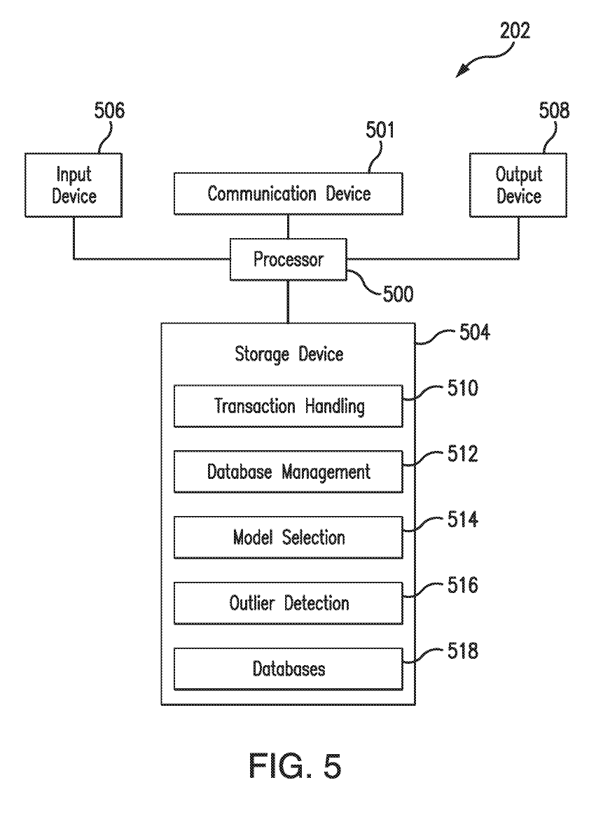

FIG. 5 is a block diagram representation of an embodiment of the transaction control server computer 202 shown in FIG. 2 as part of the payment system 200.

In some embodiments, hardware aspects of the transaction control server computer 202 may be constituted by typical server computer and/or mainframe computer hardware, but may be controlled by software to cause it to function as described herein.

The transaction control server computer 202 may include a processor 500 operatively coupled to a communication device 501, a storage device 504, an input device 506 and an output device 508. The communication device 501, the storage device 504, the input device 506 and the output device 508 may all be in communication with the processor 500.

The processor 500 may be constituted by one or more processors. The processor 500 may operate to execute processor-executable steps, contained in program instructions described below, so as to control the transaction control server computer 202 to provide desired functionality.

Communication device 501 may be used to facilitate communication with, for example, other devices (such as one or more components of the payment network 110a). For example, communication device 501 may comprise numerous communication ports (not separately shown), to allow the transaction control server computer 202 to engage in data communication simultaneously concerning numerous payment account transaction requests.

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the transaction control server computer 202, executed by the processor 500 to cause the transaction control server computer 202 to function as described herein.

The programs may include one or more conventional operating systems (not shown) that control the processor 500 so as to manage and coordinate activities and sharing of resources in the transaction control server computer 202, and to serve as a host for application programs (described below) that run on the transaction control server computer 202.

The programs stored in the storage device 504 may also include a transaction handling application program 510. The transaction handling application program 510 may control the processor 500 to support functionality of the transaction control server computer 202 to receive and handle payment account transaction requests in a manner described below.

The storage device 504 may also store a database management program 512. The database management program may control the processor 500 to store and retrieve payment account transaction data in a manner described herein.

Further, the storage device 504 may store outlier detection model selection software 514. The outlier detection model selection software 514 may control the processor 500 such that the transaction control server computer 202 selects outlier detection models for each set of account- and merchant-category-specific data according to the suitability of the type of model to the data in the data set.

Still further, the storage device 504 may store outlier detection software 516. The outlier detection software 516 may control the processor 500 to control the transaction control server computer 202 to detect outlier transactions among the requests for payment account transaction referred to the transaction control server computer 202. Details will be provided below as to how, in some embodiments, the transaction control server computer 202 may perform outlier detection under the control of the outlier detection software 516.

The storage device 504 may also store, and the transaction control server computer 202 may also execute, other programs, which are not shown. For example, such other programs may also include, e.g., device drivers, communications software, etc.

In some embodiments, the storage device 504 may also store a database 518 of previous payment account transactions to be analyzed for the purpose of outlier detection. In addition, the storage device 504 may store other databases (not shown) that may be required for the operation of the transaction control server computer 202.

In some embodiments, the transaction control server computer 202 may be associated with the payment network 110a and/or under common operation with the payment network 110a. For example, in some embodiments the transaction control server computer 202 may be combined with or at least partially overlap with a computer or computers that provide the type of functionality available via the “InControl” service offered by Mastercard International Incorporated, the assignee hereof. As will be familiar to those who are skilled in the art, the “InControl” service provides features such as transaction alerts and voluntary transaction limit settings to holders of Mastercard-branded payment card accounts.

In other embodiments, at least some of the functionality ascribed herein to the transaction control server computer 202 may alternatively be provided by a suitably programmed/modified embodiment of the issuer server computer (represented by reference numeral 112a in FIG. 2).

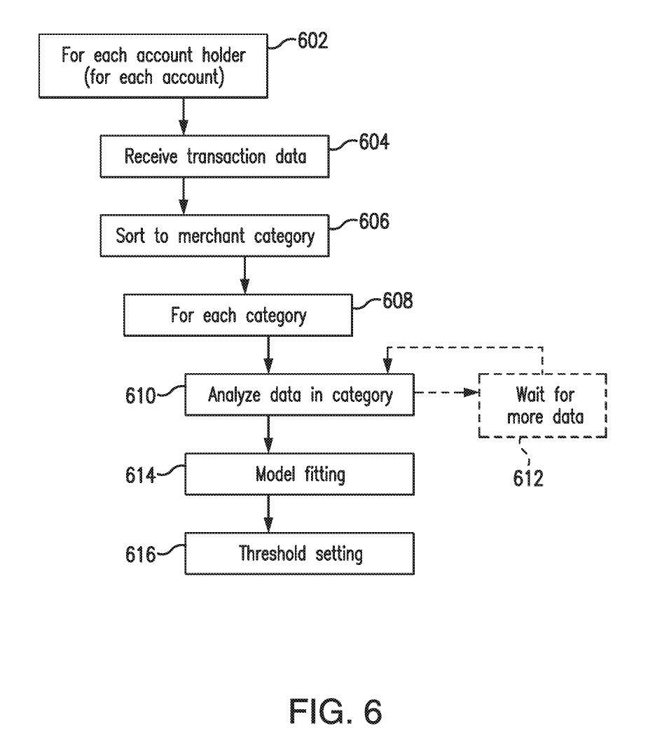

FIG. 6 is a flow chart that illustrates aspects of the present disclosure. In some embodiments, FIG. 6 may represent processing that is performed at the transaction control server computer 202.

Block 602 in FIG. 6 indicates that the subsequent processing blocks represent processes performed for each account holder and/or each payment system account assigned for oversight/PIN-entry management by the transaction control server computer 202.

At block 604 in FIG. 6, the transaction control server computer 202 receives data that represents payment account system transactions engaged in by the account holder and/or for the particular account currently under consideration. It should be recognized that this transaction data may be received over time as transactions take place and may include transactions which are authorized (by the account issuer) and consummated after having been previously submitted for possible outlier detection by the transaction control server computer 202.

At block 606 in FIG. 6, the transaction control server computer 202 sorts the transaction data received at 604 according to the merchant category indicated in the transaction data. (As is familiar to those who are skilled in the art, all merchant/acceptors of payment account transactions are assigned to a particular merchant category in the payment system, indicated by a merchant category code—MCC—represented in the data submitted and stored for each proposed payment account system transaction. As is well known to those who are skilled in the art, many merchant categories have been established for use in payment account system transactions. The established merchant categories include a category for fast food restaurants, a category for department stores, a category for supermarkets/grocery stores, and numerous other merchant categories.) As a result of the processing of FIG. 6, the transaction control server computer 202 stores, for each account holder/account the transactions engaged in by the account holder/account sorted into data entries for each category of merchant with which the account holder has transacted. Each record in the data entry may also indicate the transaction total amount and possibly also the date of the transaction.

Block 608 in FIG. 6 indicates that each subsequent processing block is relevant to each merchant category data entry for the current account holder/payment system account. At block 610, the transactions sorted to the current merchant category data entry may be analyzed. More specifically, the corresponding distribution of transaction amounts may be analyzed. (In some embodiments, more than one transaction must be represented in the current merchant category data entry for transaction amount distribution analysis to occur. Accordingly, if there are not at least two transactions represented, then the analysis of block 610 may be deferred—as indicated by phantom block 612—until sufficient transaction data has been sorted to/stored in the current merchant category data entry. In some alternative embodiments, the minimum number of transactions required for analysis may be greater than two.)

Based on the analysis at block 610, an outlier detection model may be fitted to the distribution of transaction amounts, as represented by block 614. In some instances, a Gaussian model may be selected as the best fitting model for the transaction amount data distribution. In other instances, a log normal model may be selected as the best-fitting model for the distribution of transaction amount data. In other embodiments and/or in other instances, other varieties of outlier detection models may be applied at block 614. The model fitting at block 614 may proceed in accordance with known principles for fitting models to data sets.

At block 616, using the model selected at 614, an outlier detection threshold may be set based on a predetermined criterion. For example, in the case of a Gaussian model, the threshold may be set as a nominal transaction amount that corresponds to a positive one sigma point calculated based on the Gaussian curve fitted to the data distribution. Alternatively, a positive one-and-one-half sigma or positive two sigma point may be used to calculate the outlier detection threshold. Other specific degrees of sigma may be used instead of those just specified.

In instances where a log normal model was selected at block 614, the resulting log normal curve may be transformed to a Gaussian curve, the threshold point may be determined according to one of the criterion referred to in the previous paragraph, and then the Gaussian curve including the calculated threshold point may be transformed back to the original log normal curve to indicate the threshold point on the log normal curve.

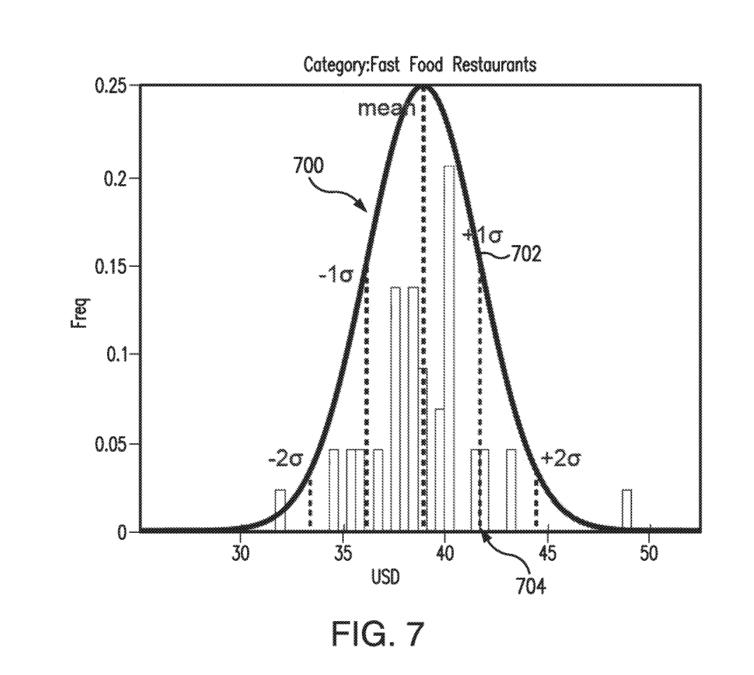

FIG. 7 is a histogram of simulated example transaction amount data for transactions in the merchant category of “fast food restaurants” for transactions by a particular account holder; FIG. 7 represents an illustration of the processing at blocks 610, 614 and 616 in FIG. 6. In the example of FIG. 7, a Gaussian model was selected as best fitting the distribution of transaction amounts. The vertical axis of the histogram indicates frequency of a particular transaction amount in the data set. The horizontal axis of the histogram indicates the transaction amount (in USD). The Gaussian model curve 700 is shown fitted to the data represented by the histogram bars. It is assumed in this instance that the outlier threshold is to be calculated as the positive one sigma point (reference numeral 702 on the model curve 700). This point on the model curve corresponds to a nominal transaction amount of USD 43.00 as indicated at 704. Thus USD 43.00 is calculated to be the outlier detection threshold for the fast food restaurant merchant category of transactions for this particular account holder based on analysis of the simulated data set shown in FIG. 7.

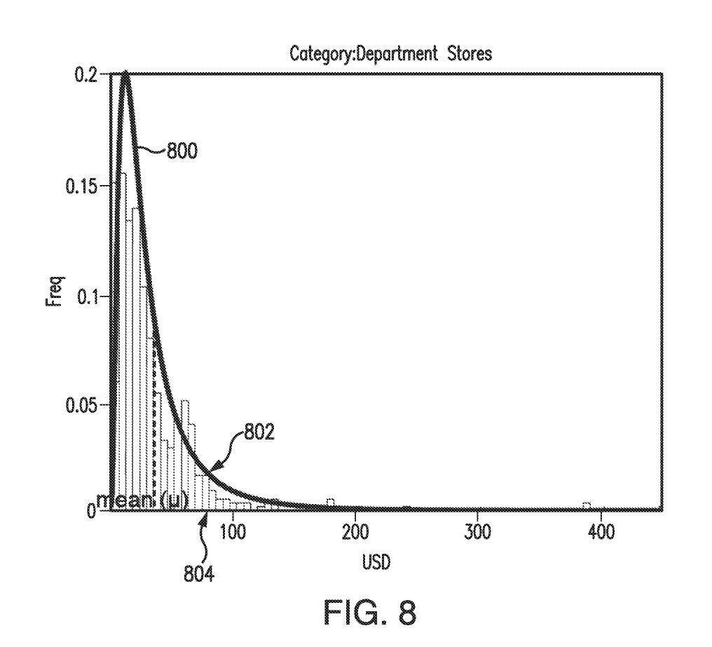

FIG. 8 is a histogram of simulated transaction amount data for transactions in the merchant category of “department stores” for transactions by a particular account holder; FIG. 8 represents another illustration of the processing at blocks 610, 614 and 616 in FIG. 6. In FIG. 8, a log normal model was selected as best fitting the distribution of transaction amounts. The vertical axis of the histogram indicates frequency of a particular transaction amount in the data set. The horizontal axis of the histogram indicates the transaction amount (in USD). The log normal model curve 800 is shown fitted to the data represented by the histogram bars. It is assumed in this instance that the outlier threshold point on the curve was calculated to fall at 802, corresponding to a nominal transaction amount of USD 88.00 as indicated at 804. Thus in this instance USD 88.00 was calculated to be the outlier detection threshold for the department stores merchant category of transactions for this particular account holder based on analysis of the simulated data set shown in FIG. 8. It is assumed that the outlier threshold in this instance reflects predetermined criteria for setting the threshold point on the model curve 800. For example, as described above, the log normal curve may have been transformed to a Gaussian curve to set the threshold point, and then the reverse transformation was made to apply the threshold point to the log normal curve.

In some embodiments, for each merchant category (and for each account holder) the outlier threshold analysis and calculation may be updated regularly, or even dynamically each time new transaction data is received in the merchant category in question. In some embodiments, individual transaction data records may become stale and be discarded with the passage of time (e.g., after a year has elapsed since the transaction date). Discarding of stale data may also be dynamically reflected by recalculation of the outlier detection threshold.

In view of block 608 in FIG. 6, the analysis, etc. of blocks 610, 614, 616 may be performed, for a given account holder, with respect to a number of different merchant categories, say three, four or more merchant categories.

In view of block 602, the data collection and category-wise outlier threshold setting may be performed with respect to a number of different account holders—potentially for quite a large number of account holders—i.e., thousands, hundreds of thousands, or even more.

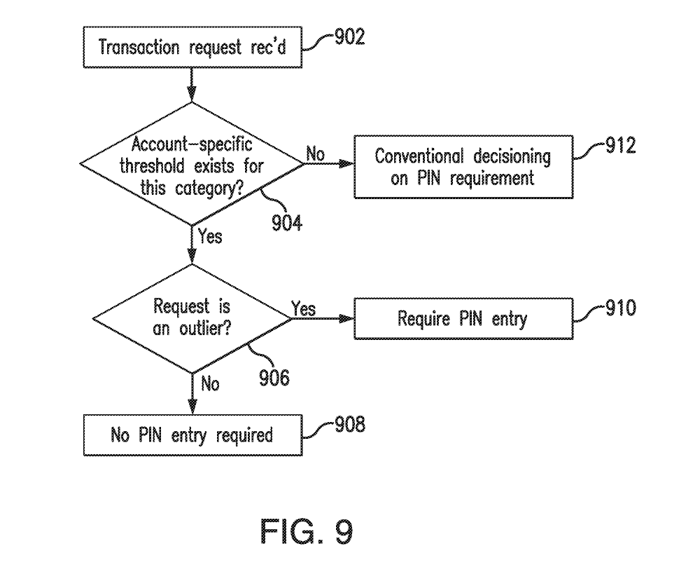

FIG. 9 is a flow chart that illustrates a process that may be performed according to aspects of the present disclosure. In some embodiments, the process of FIG. 9 may be performed by the transaction control server computer 202.

At block 902 in FIG. 9, the transaction control server computer 202 may receive a payment account system request for the purpose of determining whether PIN entry should be required for this transaction. It may be assumed that the transaction in question was initiated as a contactless transaction at the point of sale. It may be the case that the payment network 110a may be operative to detect when it has received a contactless transaction authorization request message pertaining to an account for which a variable PIN-entry threshold has been implemented, and when a request message is detected as such, the payment network 110a may forward the request message to the transaction control server computer 202, resulting in the process step 902.

In the process of FIG. 9, a decision block 904 may follow block 902. At decision block 904, the transaction control server computer 202 may determine whether an outlier detection threshold has been determined (as in the process of FIG. 6) for this particular account and for the category of merchant indicated in the transaction request message received at 202. For example, the transaction control server computer 202 may access the database 518 (FIG. 5) to determine whether a pertinent outlier detection threshold has been stored in the database 518. If so, then decision block 906 may follow decision block 904 in the process of FIG. 9.

At decision block 906, the transaction control server computer 202 may determine whether the transaction request received at block 902 is an “outlier”. For example, in making this determination, the transaction control server computer 202 may compare the transaction amount indicated in the transaction request with the pertinent outlier detection threshold. If the transaction amount exceeds the outlier detection threshold, then a positive determination may be made at decision block 906. If the transaction amount does not exceed the outlier detection threshold, then a negative determination may be made at decision block 906.

If a negative determination is made at decision block 906, then block 908 may follow decision block 906 in the process of FIG. 9. At block 908, the transaction control server computer 202 acts such that no PIN entry in required. For example, as part of the processing of block 908, the transaction control server computer 202 may signal back to the payment network 110a that no PIN entry is required. The payment network 110a may then route the transaction authorization request message to the issuer 112 without PIN entry having been required for the transaction.

If a positive determination is made at decision block 906, then block 910 may follow decision block 906. At block 910, the transaction control server computer 202 may act in such a manner that PIN entry is required for the requested transaction. For example, the transaction control server computer 202 may signal back to the payment network 110a to indicate that the transaction has been found to be an outlier and that PIN entry is required. The payment network 110a may then route a message to the point of sale to indicate that the point of sale is to request PIN entry from the account holder/user.

Referring again to decision block 904, it may be the case that a negative determination occurs (i.e., a determination that no pertinent outlier detection threshold has been set for this account and for this merchant category). If a negative determination is made at decision block 904, then block 912 may follow decision block 904. At block 912, a conventional decision-making process on whether to require PIN entry may prevail. For example, the process may be passed back to the point of sale to apply a standard, predetermined threshold in deciding whether to require PIN entry. Alternatively, the transaction control server computer 202, the payment network 110a or the account issuer may apply a standard threshold amount to determine whether PIN entry is to be required for the transaction. In some embodiments, alternatively, PIN entry may simply not be required when no outlier detection threshold has been established for an account and merchant category combination. As still another alternative, PIN entry may always be required when no outlier detection threshold has been established for the account and merchant category combination.

It is to be understood that the process of FIG. 9 may be applied by the transaction control server computer 202 with respect to transaction requests for many different accounts/account holders. For a given account holder, the process of FIG. 9 may be applied to a considerable number of transactions over a length of time. Again, for a given account holder, the process of FIG. 9 may be applied to transactions in a number of different merchant categories (e.g., at least three or more), with results that vary from transaction to transaction, from merchant category to merchant category, and also with variations in outcomes over time. For different account holders there may be differences as to which merchant categories for which outlier detection thresholds have been set. In many instances, respective individualized outlier detection thresholds may be set and applied in several (or a considerable number) of the same merchant categories for quite a large number of different account holders/accounts. The outlier detection thresholds, as mentioned above in connection with FIG. 6, may be updated over time as new transactions are received or as old transactions become stale and are purged from the relevant data entries.

With processes as described in FIGS. 6 and 9, decisions as to when to require PIN entry for contactless payment account transactions may be made in a manner that reflects a user's actual spending habits, with PIN entry being required only or largely for “outlier” transactions. Accordingly, the trade-off between convenience and security for contactless payment transactions may be improved by having fewer transactions with PIN entry required while not substantially increasing the security risk relative to conventional practices in which a “one size fits all” threshold amount is used.

In some embodiments, as is conventional, PIN entry may be required for the next transaction (regardless of transaction amount) after a certain number (say, four or five) of consecutive transactions in which PIN entry was not required. A counter for that purpose may be maintained, e.g., in the payment device, at the account issuer computer, or in another convenient location.

In some embodiments, all the transactions stored for outlier detection analysis may be contactless transactions. In other embodiments, other types of transactions are also included. In some embodiments, online transactions are not included among the stored transactions for outlier detection analysis.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
storing records of a first plurality of payment account system transactions, said first plurality of payment account system transactions all pertaining to a first category of merchants and all performed by an account holder;
receiving a first request from said account holder for a contactless payment account system transaction at a first merchant in said first category of merchants;
performing a first outlier detection analysis regarding said first request based on said stored records of said first plurality of payment account system transactions;
based on a result of said first outlier analysis, determining whether to require PIN (personal identification number) entry with regard to said first request;
storing records of a second plurality of payment account system transactions, said second plurality of payment account system transactions all pertaining to a second category of merchants and all performed by said account holder, said second category of merchants different from said first category of merchants;
receiving a second request from said account holder for a contactless payment account system transaction at a second merchant in said second category of merchants, said second merchant different from said first merchant;
performing a second outlier detection analysis regarding said second request based on said stored records of said second plurality of payment account system transactions;
based on a result of said second outlier analysis, determining whether to require PIN entry with regard to said second request;
storing records of a third plurality of payment account system transactions, said third plurality of payment account system transactions all pertaining to a third category of merchants and all performed by said account holder, said third category of merchants different from said first and second categories of merchants;
receiving a third request from said account holder for a contactless payment account system transaction at a third merchant in said third category of merchants, said third merchant different from said first and second merchants;
performing a third outlier detection analysis regarding said third request based on said stored records of said third plurality of payment account system transactions; and
based on a result of said third outlier analysis, determining whether to require PIN entry with regard to said third request.

2. The method of claim 1, wherein:
said first outlier detection analysis uses a first outlier detection model; and
said second outlier detection analysis uses a second outlier detection model different from said first outlier detection model.

3. The method of claim 2, wherein:
said first outlier detection model is a Gaussian model; and
said second outlier detection model is a log normal model.

4. The method of claim 3, wherein the Gaussian model employs a threshold amount based on one of (a) a one sigma calculation; (b) a one-and-one-half sigma calculation; and (c) a two sigma calculation.

5. The method of claim 1, wherein:
the first category of merchants is fast food restaurants;
the second category of merchants is supermarkets; and
the third category of merchants is department stores.

6. The method of claim 1, wherein said records of said first, second and third pluralities of payment account system transactions are stored in a computer operated by an operator of a payment account system.

7. The method of claim 1, wherein said records of said first, second and third pluralities of payment account system transactions are stored in a computer operated by an issuer of the account holder's payment system account.

8. The method of claim 1, wherein the account holder is a first account holder;
the method further comprising:
storing records of a fourth plurality of payment account system transactions, said fourth plurality of payment account system transactions all pertaining to said first category of merchants and all performed by a second account holder, said second account holder different from the first account holder;
receiving a fourth request from said second account holder for a contactless payment account system transaction at a fourth merchant in said first category of merchants, said fourth merchant different from said first, second and third merchants;
performing a fourth outlier detection analysis regarding said fourth request based on said stored records of said fourth plurality of payment account system transactions;
based on a result of said fourth outlier analysis, determining whether to require PIN entry with regard to said fourth request;
storing records of a fifth plurality of payment account system transactions, said fifth plurality of payment account system transactions all pertaining to said second category of merchants and all performed by said second account holder;
receiving a fifth request from said second account holder for a contactless payment account system transaction at a fifth merchant in said second category of merchants, said fifth merchant different from said first, second, third and fourth merchants;
performing a fifth outlier detection analysis regarding said fifth request based on said stored records of said fifth plurality of payment account system transactions;
based on a result of said fifth outlier analysis, determining whether to require PIN entry with regard to said fifth request;
storing records of a sixth plurality of payment account system transactions, said sixth plurality of payment account system transactions all pertaining to said third category of merchants and all performed by said second account holder;
receiving a sixth request from said second account holder for a contactless payment account system transaction at a sixth merchant in said third category of merchants, said sixth merchant different from said first, second, third, fourth and fifth merchants;
performing a sixth outlier detection analysis regarding said sixth request based on said stored records of said sixth plurality of payment account system transactions; and
based on a result of said sixth outlier analysis, determining whether to require PIN entry with regard to said sixth request.

9. The method of claim 1, wherein said contactless payment transaction at said first merchant is initiated using a payment-enabled mobile device.

10. The method of claim 1, wherein said contactless payment transaction at said first merchant is initiated using an IC (integrated circuit) payment card.

11. A method comprising:
storing records of a plurality of payment account system transactions, said plurality of payment account system transactions all pertaining to a category of merchants and all performed by an account holder;
receiving a request from said account holder for a contactless payment account system transaction at a merchant in said category of merchants;
performing an outlier detection analysis regarding said request based on said stored records of said plurality of payment account system transactions; and
based on a result of said outlier analysis, determining whether to require PIN (personal identification number) entry with regard to said request.

12. The method of claim 11, wherein said outlier detection analysis uses an outlier detection model.

13. The method of claim 12, wherein said outlier detection model is a Gaussian model.

14. The method of claim 13, wherein the Gaussian model employs a threshold amount based on one of (a) a one sigma calculation; (b) a one-and-one-half sigma calculation; and (c) a two sigma calculation.

15. The method of claim 12, wherein said outlier detection model is a log normal model.

16. An apparatus comprising:
a processor; and
a memory device in communication with the processor, the memory device storing program instructions, the processor operative with the program instructions to perform functions as follows:
storing records of a plurality of payment account system transactions, said plurality of payment account system transactions all pertaining to a category of merchants and all performed by an account holder;
receiving a request from said account holder for a contactless payment account system transaction at a merchant in said category of merchants;
performing an outlier detection analysis regarding said request based on said stored records of said plurality of payment account system transactions; and
based on a result of said outlier analysis, determining whether to require PIN (personal identification number) entry with regard to said request.

17. The apparatus of claim 16, wherein said outlier detection analysis uses an outlier detection model.

18. The apparatus of claim 17, wherein said outlier detection model is a Gaussian model.

19. The apparatus of claim 18, wherein the Gaussian model employs a threshold amount based on one of (a) a one sigma calculation; (b) a one-and-one-half sigma calculation; and (c) a two sigma calculation.

20. The apparatus of claim 17, wherein said outlier detection model is a log normal model.
